(19) United States
(12) Patent Application Publication
(10) Pub. No.: US 2013/0346218 A1
(43) Pub. Date: Dec. 26, 2013

(54) Bidding on Impression Opportunities Using Confidence Indicators

(71) Applicants: Weiguo Liu, Dublin, CA (US); Tak Yan, Palo Alto, CA (US); Victor Chu, Milpitas, CA (US)

(72) Inventors: Weiguo Liu, Dublin, CA (US); Tak Yan, Palo Alto, CA (US); Victor Chu, Milpitas, CA (US)

(73) Assignee: MICROSOFT CORPORATION, Redmond, WA (US)

(21) Appl. No.: 13/528,898

(22) Filed: Jun. 21, 2012

(51) Int. Cl. G06Q 30/02

(52) U.S. Cl. 705/14.71

(57) ABSTRACT

Various embodiments pertain to techniques for utilizing confidence indicators to adjust bidding values used to obtain impression opportunities. In various embodiments, a system clusters a plurality of ad impression opportunities according to received information regarding each of the ad impression opportunities. Information about the clusters, referred to as data spots, is calculated and utilized to classify the data spots into one or more categories. Bidding strategies are assigned to each category. When the system receives an ad impression opportunity from an impression provider, the system identifies a data spot to which the received ad impression opportunity corresponds and determines a bid for the ad impression opportunity according to the bidding strategy assigned to the category into which the identified data spot is classified.

### BACKGROUND

Online publishers typically provide or allocate portions of their online media surfaces (including web pages and applications), for advertising purposes as a means of media monetization. When this media is used, loaded or viewed, there is an opportunity to populate these areas with an advertisement, sometimes referred to as an impression opportunity. Some of the impression opportunities are available for advertising products, services or businesses not directly provided by or related to the online publishers. These impression opportunities can be made available to advertisers and/or advertising agencies for a price either directly, or through various platforms operating as middlemen such as one or more advertising networks (sometimes referred to as “ad networks”), one or more demand-side platforms (DSPs), or one or more real-time bidding (“RTB”) platforms such as advertising exchanges (sometimes referred to as “ad exchanges”). In some instances, ad exchanges provide a platform for the buying and selling of advertising impressions by consolidating and managing impression opportunities across a number of publishers or resellers and making them available for a number of advertisers or advertising agencies or other resellers, usually through a RTB platform. Advertisers interested in impression opportunities may be represented by one or more advertising agencies that procure or buy impression opportunities based on the advertising campaign using the RTB platform.

Entities that bid using RTB platforms typically utilize a “true value” estimate to determine a bidding amount. The true value estimation is a prediction of the amount that each impression is worth to the bidder. However, the true value estimation can result in high levels of uncertainty. For example, a true value based on only general information (e.g., an average true value of any impression opportunity) may be too low for impression opportunities that consistently yield higher payments from advertisers. On the other hand, the use of overly specific information in determining a true value estimate can result in higher level estimation errors, such as when an impression opportunity is not properly categorized.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments pertain to techniques for utilizing confidence indicators to adjust bidding values used to obtain impression opportunities from RTB sources. In various embodiments, a system clusters a plurality of ad impression opportunities according to received information regarding each of the ad impression opportunities, such as publisher information, user information, or the like. Information about the clusters, referred to as data spots, is calculated and utilized to divide the data spots into one or more categories. In various embodiments, calculated information includes a confidence level for the data spot and an expected cost per impression of the data spot, sometimes called the value of the data spot. Bidding strategies are assigned to each category of data spots. When the system receives an ad impression opportunity from an impression provider, the system identifies a data spot to which the received ad impression opportunity corresponds and determines a bid for the ad impression opportunity according to the bidding strategy assigned to the category into which the identified data spot is divided. In various embodiments, the bidding strategy can be a true value bidding strategy, a less true value bidding with randomness strategy, an explore bidding strategy, or an opt out strategy.

### BRIEF DESCRIPTION OF THE DRAWINGS

While the specification concludes with claims particularly pointing out and distinctly claiming the subject matter, it is believed that the embodiments will be better understood from the following description in conjunction with the accompanying figures, in which:

FIG. 1 illustrates an example operating environment in accordance with one or more embodiments;

FIG. 2 illustrates an example advertisement platform in accordance with one or more embodiments;

FIG. 3 is a block diagram of an example process in accordance with one or more embodiments;

FIG. 4 is a block diagram of an example process in accordance with one or more embodiments;

FIG. 5 is a chart depicting an example assignment of bidding strategies to categories; and

FIG. 6 illustrates an example device that can be used to implement one or more embodiments.

### DETAILED DESCRIPTION

Overview

Various embodiments pertain to techniques for utilizing confidence indicators to adjust bidding values used to obtain impression opportunities from RTB sources. In various embodiments, a system clusters a plurality of ad impression opportunities according to received information regarding each of the ad impression opportunities, such as publisher information, user information, or the like. Information about the clusters, referred to as data spots, is calculated and utilized to divide the data spots into one or more categories. In various embodiments, calculated information includes a confidence level for the data spot and an expected cost per impression of the data spot, sometimes called the value of the data spot. Bidding strategies are assigned to each category of data spots. When the system receives an ad impression opportunity from an impression provider, the system identifies a data spot to which the received ad impression opportunity corresponds and determines a bid for the ad impression opportunity according to the bidding strategy assigned to the category into which the identified data spot is divided. In various embodiments, the bidding strategy can be a true value bidding strategy, a less true value bidding with randomness strategy, an explore bidding strategy, or an opt out strategy.

In the discussion that follows, a section entitled “Example Operating Environment” describes an operating environment in accordance with one or more embodiments. Next, a section entitled “Example Embodiments” describes various embodiments utilizing confidence indicators to adjust bidding values used to obtain impression opportunities from RTB sources. A section entitled “Determining Bidding Strategies” describes various techniques for determining a bidding strategy to be used for a particular data spot. The section includes subsections entitled “Less True Value Bidding with Randomness” and “Explore Bidding,” each of which describes the named bidding strategy in detail. Finally, a section entitled “Example Device” describes a device that can be used to implement one or more embodiments.

Consider, now, an example operating environment in accordance with one or more embodiments.

Example Operating Environment

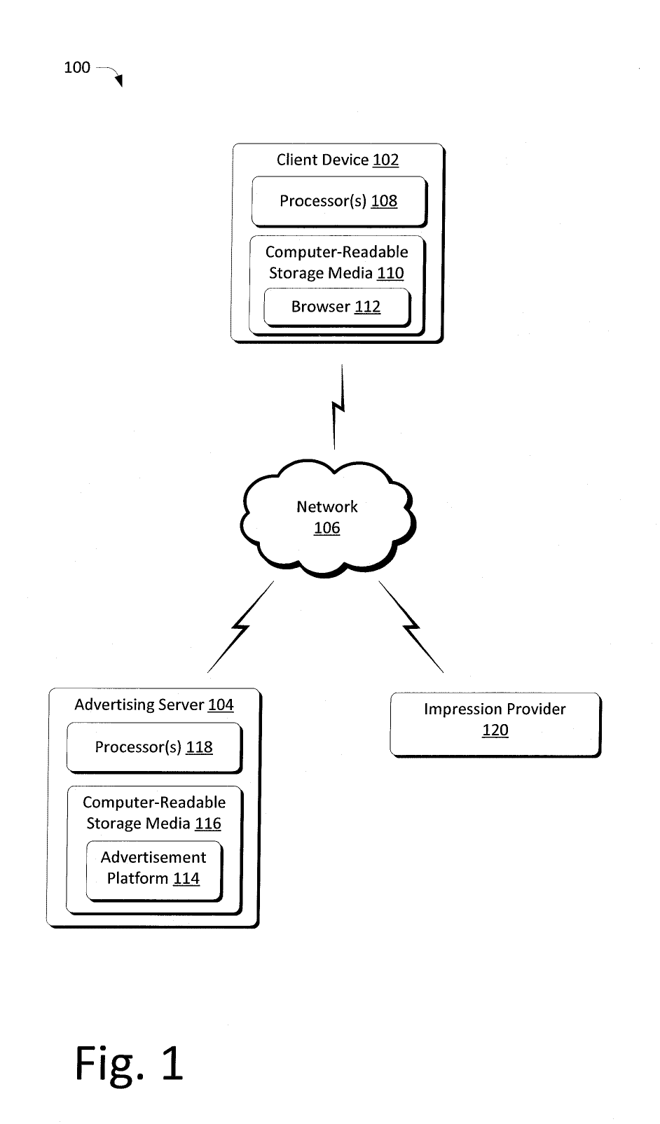

FIG. 1 is an illustration of an example environment 100 in accordance with one or more embodiments. Environment 100 includes a client device 102 communicatively coupled to an advertising server 104 through a network 106.

Client device 102 can include one or more processors 108 and computer-readable storage media 110. Client device 102 can be embodied as any suitable computing device such as, by way of example and not limitation, a desktop computer, a portable computer, a netbook, a handheld computer such as a personal digital assistant (PDA), a cell phone, and the like.

Computer-readable storage media 110 includes one or more software applications, which can include a software executable module in the form of a web browser 112. Browser 112 can receive content from and send content to other servers, such as servers hosting websites, via network 106, such as the Internet. In various embodiments, browser 112 is configured to request a web page that includes one or more ad impression opportunities. The ad impression opportunities for one or more web pages (from one or more publishers) can be purchased by an advertiser or advertising agent via advertising server 104. Advertising server 104 can provide an advertisement for the ad impression opportunity that is published as part of the web page requested by browser 112.

Ad impressions may be impression opportunities that can include any form or type of space or region on a web page or program or application. The impression opportunity may overlap with, reside within, or be part of content on the web page or program or application (e.g., locations for banners, ad blocks, sponsored listings, margin ads, flash displays, and the like), although in some embodiments, the impression opportunity does not directly reside on a web page or program or application. For example, in some embodiments, an impression opportunity in the form of a pop up window may be generated in response to a user action, such as clicking a button on an input device or causing a mouse indicator to hover over a particular portion of the web page. In some embodiments, the impression opportunity is temporal, e.g., associated with a time slot, such as before a requested video clip or at a particular time of day.

In various embodiments, impression opportunities or ad impressions from various sources, such as online publishers or ad impression resellers, can be consolidated and sold to advertisers via the advertisement platform 114. Advertisement platform 114 resides on computer-readable storage media 116 of advertising server 104. In addition to computer-readable storage media 116, advertising server 104 also includes one or more processors 118 configured to execute the software modules, e.g., advertisement platform 114, residing on computer-readable storage media 116. In various embodiments, advertisement platform 114 is configured to receive and process orders for ad impressions from an already-stored inventory database. Advertisement platform 114 is also configured to obtain ad impressions to fulfill the orders from one or more impression providers, such as impression provider 120, each of which can represent ad impressions from one or more online publishers, such as the publisher of the web page requested by client device 102.

In various embodiments, impression provider 120 is a RTB platform (e.g., a real-time bidded inventory of ad impressions). In various embodiments, RTB platforms can serve to broker transactions between advertisement platform 114 and the online publishers. For example, advertisement platform 114 may make a bid on a number of ad impressions and the RTB platform can institute an auction for the ad impressions. If advertisement platform 114 wins the auction, it can then fulfill an order by providing an advertisement to be published as part of the web page requested by client device 102.

In various embodiments, regardless of whether advertisement platform 114 wins an auction from impression provider 120, advertisement platform 114 records information about the auction, or bid landscape data. Bid landscape data can include information regarding a number of impression requests by a particular supply unit, a time of the impression requests, an amount of a winning bid for the impression requests, an amount of a winning clearing price for the impression requests, and/or other information from real-time bidding or auctioning of ad impressions. A clustering method can be applied to group historical impression requests into data spots according to various classifications of the situation to which the impression request corresponds. For example, impression requests can be grouped according to publisher or user information called features.

Publisher features may include publisher name, business category, current web page contents and titles, publisher-preferred ad categories or the like. User features may include geographic, demographic and recent behavior features, such as age, gender, location, user-preferred ad categories and so on. A data spot corresponds to a selected feature value or feature value combination. For example, assume we select three features and their values as follows: user gender (male, female), user city (NYC, SF, LA, others) and publisher (WSJ, CNN, others). There can be up to twenty-four data spots (e.g., twenty-four different possible combinations of four cities, two genders and three publishers). For example, a male from SF visiting a web page published by CNN belongs to one data spot. In various embodiments, there are a few or a few dozen features and millions of data spots. In various embodiments, each impression opportunity or ad call is associated with one data spot. Utilizing this data, advertisement platform 114 is configured to determine a confidence level for the data spot. In various embodiments, advertisement platform 114 can alter the bidding strategy utilized for the data spot in response to a determined confidence level for the data spot, as described in more detail below.

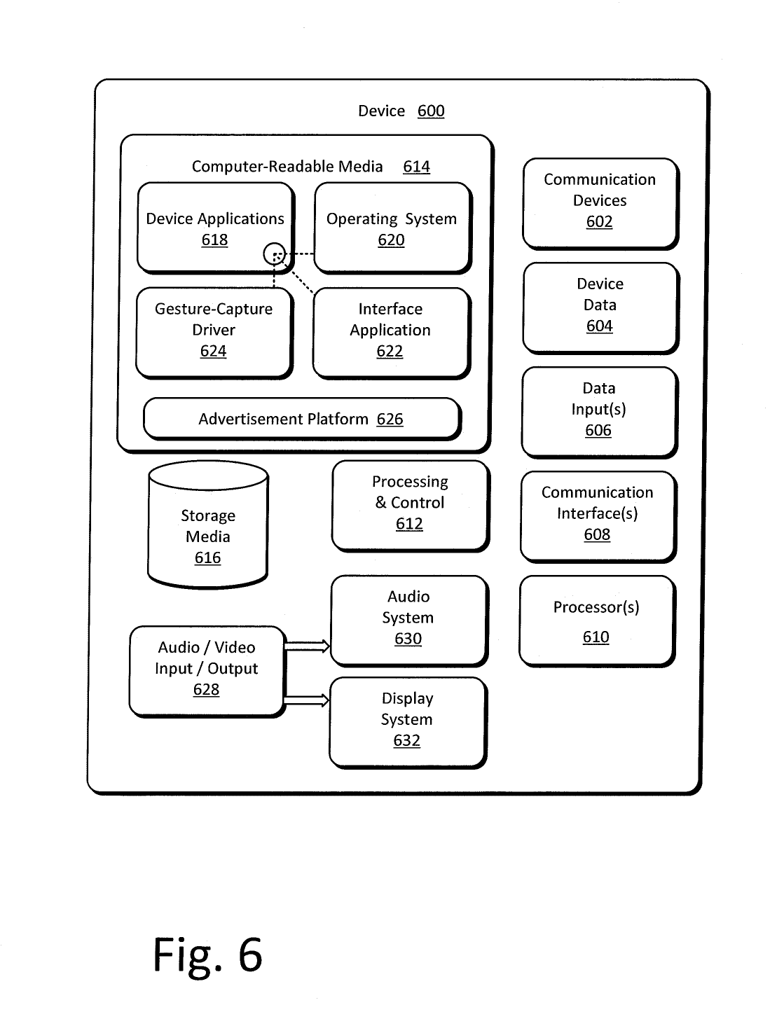

The computer-readable storage media included in each device or server can include, by way of example and not limitation, all forms of volatile and non-volatile memory and/or storage media that are typically associated with a computing device. Such media can include ROM, RAM, flash memory, hard disk, removable media and the like. One specific example of a computing device is shown and described below in FIG. 6.

Generally, any of the functions described herein can be implemented using software, firmware, hardware (e.g., fixed logic circuitry), or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer-readable memory devices. The features of the user interface techniques described below are platform-independent, meaning that the techniques may be implemented on a variety of commercial computing platforms having a variety of processors.

Environment 100 is referenced by the following description of various embodiments in which confidence indicators are utilized to adjust bidding values used to obtain impression opportunities from RTB sources.

### Example Embodiments

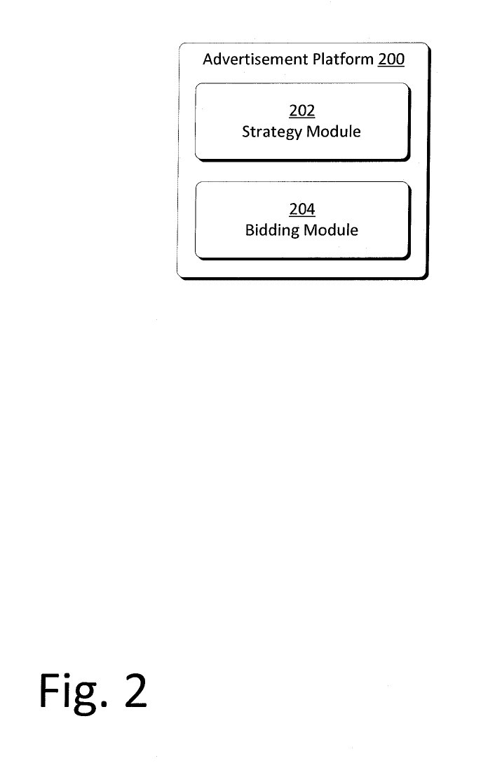

FIG. 2 illustrates an advertisement platform 200 in accordance with one or more embodiments. Advertisement platform 200 can be, for example, advertisement platform 114 as illustrated in FIG. 1. As shown in FIG. 2, advertisement platform 200 includes a strategy module 202 and a bidding module 204. Other components may be included, depending on the particular embodiment.

In one or more embodiments, strategy module 202 is configured to record information about auctions, or bid landscape data, and to determine confidence levels associated with particular data spots. Bid landscape data can include information regarding a number of impression requests by a particular supply unit, a time of the impression requests, an amount of a winning bid for the impression requests, an amount of a winning clearing price for the impression requests, and other information from real-time bidding or auctioning of ad impressions. The confidence level represents a variance of values for the data spot. For example, a particular data spot can have a value that varies according to the day of the week or time of day impression requests are served (e.g., the price required to win bids for a data spot corresponding to impression requests from a particular geographic location is highly dependent on the day of the week the request is submitted), and the data spot can be associated with a low confidence level. As another example, the winning price for bids responsive to impression requests from a particular publisher can be relatively constant, and the data spot can be associated with a high confidence level. The confidence level can also depend on a number of impressions (e.g., the more impressions in the data spot, the higher the confidence level). In various embodiments, strategy module 202 determines an appropriate bidding strategy for a data spot to be implemented by bidding module 204.

In one or more embodiments, bidding module 204 is configured to receive ad impression opportunities, such as from impression providers, identify ad impression opportunities on which to bid, and transmit bids for those ad impression opportunities. In other words, bidding module 204 is configured to obtain ad impressions from impression providers for delivery to advertisers according to received orders. Working together, strategy module 202 and bidding module 204 enable advertisement platform 200 to determine an optimized bidding amount depends on the information received from an impression provider and the advertisement inventories the bidding agent has recorded.

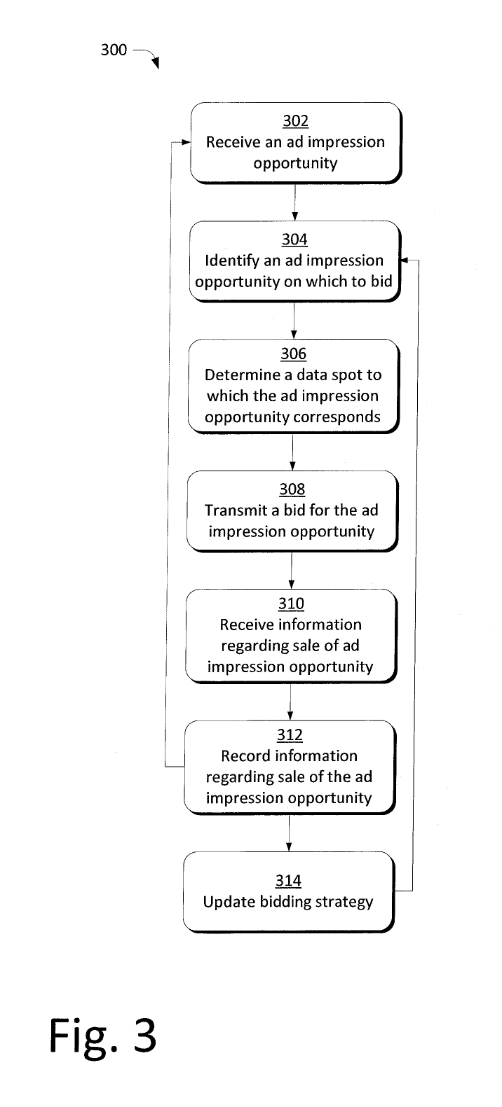

FIG. 3 is a block diagram of an example process 300 for determining an available ad impression volume in accordance with one or more embodiments. The process can be implemented in connection with any suitable hardware, software, firmware, or combination thereof. In at least some embodiments, the process can be implemented in software, such as by advertisement platform 114 or advertisement platform 200.

Block 302 receives an ad impression opportunity from a source of ad impressions. This can be performed in any suitable way. For example, advertisement platform 114 can receive one or more ad impression opportunities, sometimes called requests for a bid, from at least one impression provider, such as impression provider 120. In various embodiments, advertisement platform 114 receives ad impression opportunities from various real-time bidding platforms, in some embodiments, one or more ad networks.

Block 304 identifies an ad impression opportunity on which to bid. This can be performed in any suitable way. For example, advertisement platform 114 can determine that at least one of the ad impression opportunities received by block 302 includes inventory that can be used to fill an order for ad impressions. Some ad impression opportunities may not be suitable for bidding, since the ad impression opportunities may be related to content or audiences that are not in line with the advertiser's campaign. For example, advertisement platform 114 may receive an order for ad impressions from an advertiser running a car advertisement campaign, so ad impression opportunities on websites directed to pre-teen girls may not be desired by the advertiser for that particular campaign. However, when advertisement platform 114 receives an ad impression opportunity for space on a sports website from impression provider 120, block 304 may identify it as an ad impression opportunity on which to bid.

Next, block 306 determines a data spot to which the ad impression opportunity corresponds. This can be performed in any suitable way. For example, when advertisement platform 114 is advertisement platform 200, strategy module 202 can cluster ad impression opportunities into data spots using a clustering algorithm. The particular algorithm used can vary depending on the specific embodiment. In some embodiments, the algorithms can run offline and the results of the algorithms, including data spots and their estimated values, are provided online for quick references. In various embodiments, each ad impression received from an impression provider can include information such as, by way of example and not limitation, publisher or a user features, that can be used to cluster ad impression opportunities. Strategy module 202 can also determine an expectation of the cost per impression (“eCPI(s)”), a number of impressions (“nImps(s)”) used to derive the eCPI(s), a variance (“variance(s)”) of the data compared to the expected cost, and a number of bids submitted (“nRFBs(s)”) and a number of bids won (“nRFPs(s)”) for each data spot (“s”). In various embodiments, a win rate for a data spot can be represented according to the following equation:

$$winRate ( s ) = \{ \begin{matrix}0 , & if nRFBS ( s ) = 0 \\ \frac{nRFPs ( s )}{nRFBs ( s )} , & otherwise\end{matrix}$$

where s is the data spot, nRFPs(s) is the number of bids won, and nRFBs(s) is the number of bids submitted. The strategy module 204 can also determine a confidence level for each data spot according to the number of impressions (“nImps(s)”) and the variance of the cost per impression (“variance(s)”). In various embodiments, the strategy module 202 updates the parameters for the data spots frequently. In some embodiments, parameters are updated on a daily basis. Additionally, in various embodiments, the strategy module 202 reclusters or repartitions the data spots on a periodic basis. For example, ad impression opportunities can be reclustered on a weekly or every-other week basis. The amount of time between parameter updates or reclustering can vary depending on the particular embodiment. Data spots can then be associated with bidding strategies depending on the associated confidence level for the data spot.

Block 308 transmits a bid for the ad impression opportunity according to the bid strategy for the data spot with which the ad impression opportunity corresponds. This can be performed in any suitable way. For example, advertisement platform 114 can transmit a bid, such as $1 for an impression, to impression provider 120 through network 106. In embodiments in which advertisement platform 114 is advertisement platform 200, bidding module 204 transmits the bid. The amount of the bid transmitted can be determined according to a variety of factors, including but not limited to, the price for which the impressions have been sold to the advertiser, whether the advertiser is ahead, on track or behind their impression delivery goal schedule, what the competing internal and external demand is bidding, a cap identified by the advertiser, historical data gathered by advertisement platform 114, or the like.

Next, block 310 receives information regarding the sale of the ad impression opportunity. For example, block 310 can receive information that the bid transmitted by block 308 is a winning bid, that there has been a higher bid than the one transmitted by block 306, that the auction for the ad impression opportunity was won or lost, or information regarding the winning bid amount. This can be performed in any suitable way. For example, advertisement platform 114 can receive information regarding the outcome of the ad impression from impression provider 120 through network 106. In some embodiments, the information received by block 310 is information that a notification of a win on a bid was not received. For example, if a notification that an auction was won is not received within a predetermined amount of time responsive to block 308 transmitting a bid, advertisement platform can receive information indicating that no information was received. In some embodiments, the received information can be generated by bidding module 204 and received by strategy module 202.

Block 312 records the information regarding the sale of the ad impression opportunity that was received by block 310. This can be performed in any suitable way. For example, advertisement platform 114 can cause the information received from impression provider 120 to be stored on computer-readable storage media 116 of advertising server 104. The loop from block 302 through 312 is repeated for each ad impression opportunity received. In some embodiments, information regarding an ad impression opportunity is recorded regardless of whether block 304 identifies it as an opportunity on which to bid. In other embodiments, information recorded can be limited to information regarding ad impression opportunities for which block 308 transmits a bid.

In various embodiments, information regarding a user click on the advertisement and a payment amount is recorded. For example, assume that a pay-per-click revenue system is employed. When a user clicks on the served advertisement presented, the click and/or the amount paid by the advertiser, as determined by the terms of the sale of the ad impression opportunity, can be recorded. The bidding strategies as described in detail herein are not limited to any particular revenue model (e.g., pay per click, pay per impression, or pay per acquisition models). Information recorded, including bidding information, win information, pricing information and user responses, are used to update the data spots and categories. The recorded information can also be utilized to tune the strategies and the assignments of the strategies to the one or more categories.

After information regarding the outcome of the ad impression opportunity is recorded by block 312, block 314 updates a bidding strategy. This can be performed in any suitable way. For example, in embodiments in which advertisement platform 114 is advertisement platform 200, strategy module 202 can utilize the recorded information, update the bidding strategy for the data spot to which the received ad impression opportunity corresponds or assign a different bidding strategy assigned to the category into which the data spot is classified. In various embodiments, the bidding strategy can be adjusted in real-time when bidded values differ greatly from winning values for a given data spot. In some embodiments, the bidding strategy is updated on a periodic basis, such as hourly or daily.

Having described various embodiments in which bids are transmitted according to a bidding strategy, consider the following description of techniques for determining a bidding strategy for use with a given data spot or category of data spots.

Determining Bidding Strategies

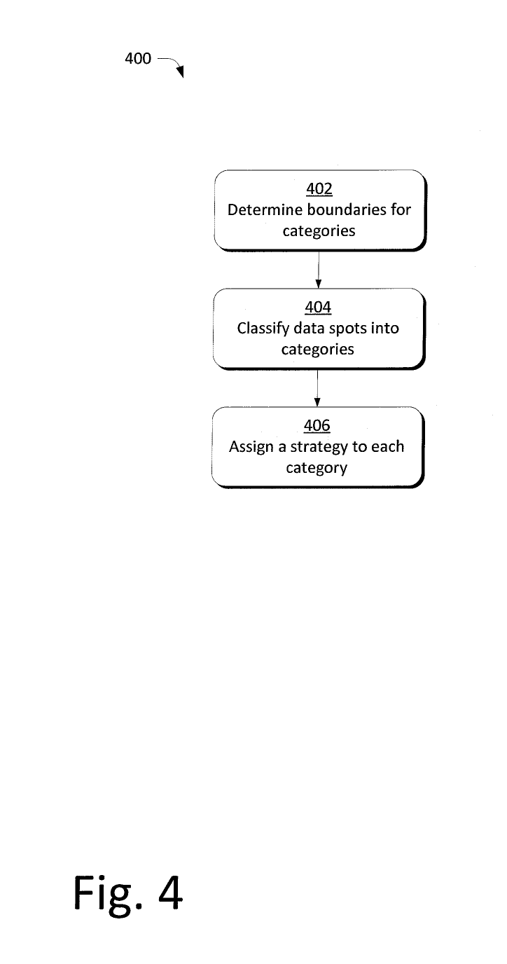

FIG. 4 is a block diagram of an example process 400 for associating a bidding strategy with a data spot in accordance with one or more embodiments. The process can be implemented in connection with any suitable hardware, software, firmware, or combination thereof. In at least some embodiments, the process can be implemented in software, such as by strategy module 202.

Block 402 determines boundaries for categories. This can be performed in any suitable way. For example, the expected cost per impression and the confidence indicators for each data spot can used to separate data spots into various categories. Other metrics associated with each data spot can similarly be used to separate data spots into categories, depending on the particular embodiment. A high and low boundary value for each metric is determined to define categories into which the data spots will be classified. The values for each boundary can be calculated in any suitable way. For example, the data can be sorted according to the metric and percentiles can be used to set a boundary.

As an example, assume that the expected cost per impression (eCPI(s)) and the confidence level are used to categorize data spots. Boundaries, GlobalHiImps, GlobalLoImps, GlobalHiPrice and GlobalLoPrice, are calculated according to the data for each metric. In various embodiments, GlobalHiImps and GlobalHiPrice are set to the value of the seventy-fifth percentile (e.g., 75% of the values for the metric fall below the GlobalHiImps and GlobalHiPrice), and GlobalLoImps and GlobalLoPrice are set to the value of the twenty-fifth percentile (e.g., 75% of the values for the metric are above the GlobalLoImps and GlobalLoPrice).

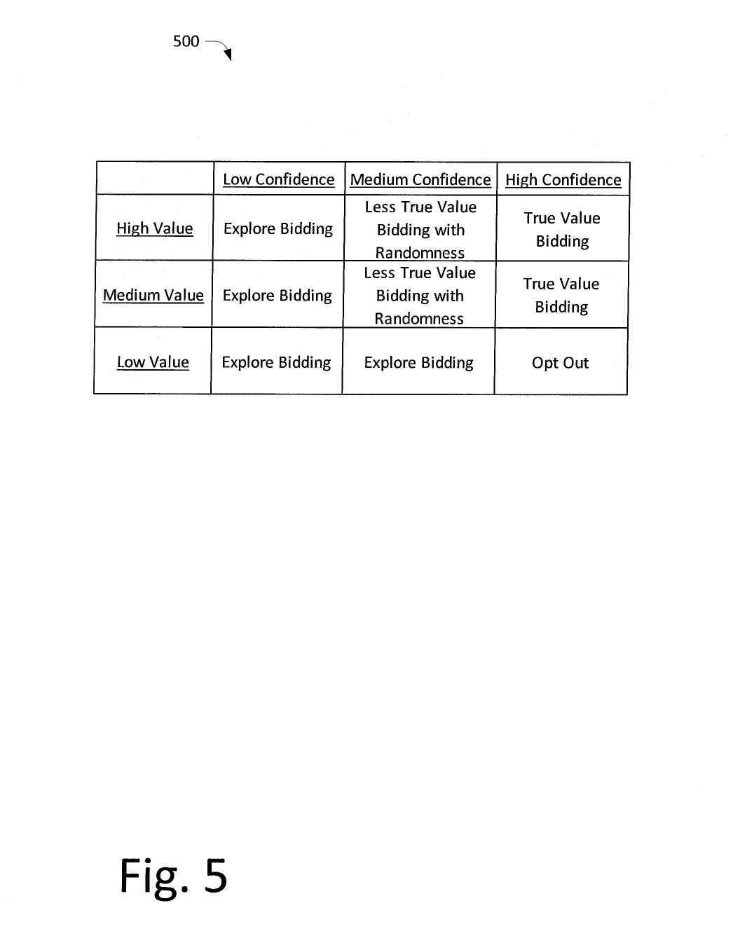

Block 404 classifies the data spots into categories. This can be performed in any suitable way. For example, if the number of impressions for a data spot (nImps(s)) is less than the GlobalLoImps, the confidence level for the data spot can be categorized as “low confidence.” When the number of impressions for a data spot (nImps(s)) is greater than or equal to the GlobalHiImps, the confidence level for the data spot can be categorized as “high confidence.” For data spots in which the number of impressions is between the GlobalLowImps and the GlobalHiImps, the confidence level can be categorized as “medium confidence.” Likewise, if the expected cost per impression for a data spot (eCPI(s)) is less than the GlobalLoPrice, the value for the data spot can be categorized as “low value.” When the expected cost per impression for a data spot (eCPI(s)) is greater than or equal to the GlobalHiPrice, the value level for the data spot can be categorized as “high value.” For data spots in which the expected cost per impression is between the GlobalLowPrice and the GlobalHiPrice, the value level can be categorized as “medium value.” The high, medium and low confidence levels and high, medium and low value levels can be used to divide the data spots into nine categories, which can be represented by a grid, such as the one depicted in FIG. 5. FIG. 5 illustrates an example bidding strategy assignment chart 500. In chart 500, columns are used to separate the data spots by confidence level while rows are used to separate the data spots by value level. Depending on the values for each data spot, the data spot will fall into one of the nine categories in the chart (e.g., low confidence, high value; high confidence; medium value; etc.)

Next, block 406 assigns a strategy to each category. This can be performed in any suitable way. For example, a bidding strategy can be assigned to each of the nine categories, as shown in FIG. 5. Within chart 500, each category is assigned one of four bidding strategies (e.g., explore bidding, less true value bidding with randomness, true value bidding, and opt out). Additional or alternative bidding strategies can be employed depending on the particular embodiment, and may be associated with different categories. The bidding strategy assigned to the category into which a particular data spot falls will be used by bidding module 204 to determine the appropriate bid to be transmitted for a given ad impression opportunity. In various embodiments, bidding strategies assigned to each category can be subsequently altered according to defined business plans of the advertisers or advertiser agent. For example, a particular category can initially be assigned a true value bidding strategy, but the category can subsequently be assigned a less true value bidding with randomness strategy to meet certain goals or quotas. Other considerations can be used to alter the bidding strategy assigned to each category depending on the particular embodiment.

In various embodiments, for data spots having a high confidence level and a low value level, the bidding strategy is to opt out. In other words, the system does not transmit a bid for the ad impression opportunity.

Various embodiments include associating “true value bidding” strategy with categories having a high confidence level (and a medium or high value level). Using the true value bidding strategy, bidding module 204 submits a bid equal to the eCPI(s). In some embodiments, a limited amount of random bidding can also be included in this strategy.

In various embodiments, data spots having medium or low confidence levels are assigned bidding strategies that explore the data spot in order to gain confidence in the bidding values that are being submitted. Less true value bidding with randomness and explore bidding, are two of these strategies.

Less True Value Bidding with Randomness

In various embodiments, data spots that are not associated with a high confidence level can be assigned a bidding strategy that bids lower than the “true value” of the data spot. For example, the less true value bidding with randomness strategy applies a randomized bid value in addition to the average bid value. The distribution of the randomness and the range of the actual bidding are functions of both valuation and confidence levels.

Various embodiments utilize a lower bound of bidding, which serves as a guard against bidding unreasonably low. For example, the lower bound can be selected as one deviation lower than the eCPI(s). This can be represented according to an equation:

loBid(s)=max (FloorPrice, eCPI(s)−{square root over (variance(s)))}

where the FloorPrice is the minimum bidding price to quality. For data spots with lower confidence value levels, a markdown can be calculated according to an equation:

markDown(s)=f(nImp(s), variation(s))

where the function is valued between zero and one. In some embodiments, the function is selected to monotonically increase when nImp(s) increases or when the variation decreases. With the lowBid(s) and the markDown(s) values, the average bid value for the spot can be represented by the equation:

$$avgBid ( s ) = \{ \begin{matrix}eCPI ( s ) , & if nImp ( s ) \geq Global HiImps ( s ) \\ \begin{matrix}markDown ( s ) * eCPI ( s ) + \\ ( 1 - markDowns ( s ) ) * loBid ( s ) ,\end{matrix} & otherwise .\end{matrix}$$

By bidding around the true value with an amount of randomness, a more desirable win rate may be achieved. The distribution of the randomized bid can vary depending on the particular embodiment. For example, a bounded normal or log normal distribution function can be used. Additionally, the random number generator can be configurable depending on the particular embodiment.

In various embodiments, lower and upper bounds of a bidding range are calculated according to the desired win rate and a confidence level of the data spot. In some embodiments, the bounds are initially determined according to the deviations within the data spot, and can be tuned or adjusted as desired. Responsive to determining a bidding range, the randomized bid value within the bidding range can be determined in any suitable way. For example, in various embodiments, the randomized bid value is represented by an equation:

randBid=RNG(avgBid(s), loBid(s), upBid(s))

where RNG is a random number generator of a selected distribution depending on the particular embodiment, avgBid(s) is the average bid for the data spot, loBid(s) is the lower bound of the bidding range, and upBid(s) is the upper bound of the bidding range.

While the less true value bidding with randomness strategy can provide a healthy win rate, in various embodiments, the confidence level or value of the data spot indicate that exploration may be beneficial, and an explore bidding strategy is employed.

Explore Bidding

In various embodiments, explore bidding is used as a means to test the traffic while attempting to maintain a particular win rate. An average bid amount is determined according to a past win rate and trying to maintain the win rate at a desired level. In some embodiments, the model utilizes a target budget to explore various bidding scenarios rather than a target win rate. In such embodiments, r and x represent the target budget and the actual spending, respectively.

In various embodiments seeking to achieve a fixed win rate, exploration can be achieved using a feedback control theory, such as the proportional control law. The relative win rate error e can be represented according to an equation:

$$e = \frac{( r - x )}{r}$$

where r is the target win rate and x is the actual win rate. Explore bidding can be broken down into four zones or situations: seed zone (e.g., no bidding history), acceleration zone (e.g., current win rate is much less than the target), bid increment zone (e.g., the win rate has passed the acceleration zone but is still less than the target), and bid decrement zone (e.g., the win rate is greater than the target). Depending on the zone of the bidding strategy, the incremental change in the bid varies.

In various embodiments, when there is no bidding history and the data spot is in the seed zone, bidding module 204 uses a seed bid value, C₀. The seed bid value can vary depending on the particular embodiment, and can be set according to values acceptable to the bidder in order to develop a bidding history. In the seed zone, subsequent bids are increased by the value C₀ with respect to the preceding bid.

After a bidding history has been developed for a data spot, as the actual win rate is much lower than the target, the bidding strategy enters the acceleration zone. In the acceleration zone, bids are increased by a larger bid increment to decrease the amount of time to achieving the targeted win rate. For example, the bid increment can be represented according to an equation:

Δb=C₁e

where b is the bid amount, e is the relative win rate error, and C₁ is a positive constant. The value of C₁ can vary depending on the particular embodiment.

As the actual win rate approaches the target win rate, the bidding strategy enters the bid increment zone. In the bid increment zone, bids are increased, but at a slower rate than in the acceleration zone. For example, the bid increment can be represented according to an equation:

Δb=C₂e

where b is the bid amount, e is the relative win rate error and C₂ is a positive constant. The value of C₂ can vary depending on the particular embodiment.

Once the actual win rate has surpassed the target win rate, the bidding strategy enters the bid decrement zone. In the bid decrement zone, the bid is decreased based on the previous bid. For example, the bid decrement can be represented according to an equation:

Δb=−C₃|e|

where b is the bid amount, e is the relative win rate error and C₃ is a positive constant. The value of C₃ can vary depending on the particular embodiment.

In various embodiments, the amount of the bid change is proportional to the win rate difference. When the difference is small, the change on bid value will also be small. In various embodiments, the control law can be modified to be proportional plus differential (e.g., PD control), which will also count to change the rate of the win rate error. In some embodiments, the control law can be proportional, differential and integral (e.g., PID control) which also considers the sum of win rate errors. Though PD or PID can result in an increase in responsiveness and a decrease in steady state error, they can also make the model more complicated.

In various embodiments, win rate feedback is provided on a periodic basis (e.g., daily, hourly, or every minute). A decrease in the period of time (e.g., quicker feedback) enables the system to adjust the model quickly, potentially avoiding a budget overage. In various embodiments, randomness can be added to the calculated bid value to enable the system to gather additional information to generate the bid landscape.

Having described various techniques for bidding using confidence indicators, consider the following description of a device that can be used to implement one or more embodiments.

Example Device

FIG. 6 illustrates various components of an example device 600 that can be implemented as any type of portable and/or computer device as described with reference to FIG. 1 to implement embodiments of the advertisement platform described herein. Device 600 includes communication devices 602 that enable wired and/or wireless communication of device data 604 (e.g., received data, data that is being received, data scheduled for broadcast, data packets of the data, etc.). The device data 604 or other device content can include configuration settings of the device, media content stored on the device, and/or information associated with a user of the device. Media content stored on device 600 can include any type of audio, video, and/or image data. Device 600 includes one or more data inputs 606 via which any type of data, media content, and/or inputs can be received, such as user-selectable inputs, messages, music, television media content, recorded video content, and any other type of audio, video, and/or image data received from any content and/or data source.

Device 600 also includes communication interfaces 608 that can be implemented as any one or more of a serial and/or parallel interface, a wireless interface, any type of network interface, a modem, and as any other type of communication interface. The communication interfaces 608 provide a connection and/or communication links between device 600 and a communication network by which other electronic, computing, and communication devices communicate data with device 600.

Device 600 includes one or more processors 610 (e.g., any of microprocessors, controllers, and the like) which process various computer-executable or readable instructions to control the operation of device 600 and to implement the embodiments described above. Alternatively or in addition, device 600 can be implemented with any one or combination of hardware, firmware, or fixed logic circuitry that is implemented in connection with processing and control circuits which are generally identified at 612. Although not shown, device 600 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 600 also includes computer-readable media 614, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 600 can also include a mass storage media device 616.

Computer-readable media 614 provides data storage mechanisms to store the device data 604, as well as various device applications 618 and any other types of information and/or data related to operational aspects of device 600. For example, an operating system 620 can be maintained as a computer application with the computer-readable media 614 and executed on processors 610. The device applications 618 can include a device manager (e.g., a control application, software application, signal processing and control module, code that is native to a particular device, a hardware abstraction layer for a particular device, etc.), as well as other applications that can include, web browsers, image processing applications, communication applications such as instant messaging applications, word processing applications and a variety of other different applications. The device applications 618 also include any system components or modules to implement embodiments of the techniques described herein. In this example, the device applications 618 include an interface application 622 and a gesture-capture driver 624 that are shown as software modules and/or computer applications. The gesture-capture driver 624 is representative of software that is used to provide an interface with a device configured to capture a gesture, such as a touchscreen, track pad, camera, and so on. Alternatively or in addition, the interface application 622 and the gesture-capture driver 624 can be implemented as hardware, software, firmware, or any combination thereof. In addition, computer-readable media 614 can include an advertisement platform 626 that functions as described above.

Device 600 also includes an audio and/or video input-output system 628 that provides audio data to an audio system 630 and/or provides video data to a display system 632. The audio system 630 and/or the display system 632 can include any devices that process, display, and/or otherwise render audio, video, and image data. Video signals and audio signals can be communicated from device 600 to an audio device and/or to a display device via an RF (radio frequency) link, S-video link, composite video link, component video link, DVI (digital video interface), analog audio connection, or other similar communication link. In an embodiment, the audio system 630 and/or the display system 632 are implemented as external components to device 600. Alternatively, the audio system 630 and/or the display system 632 are implemented as integrated components of example device 600.

While various embodiments have been described above, it should be understood that they have been presented by way of example, and not limitation. It will be apparent to persons skilled in the relevant art(s) that various changes in form and detail can be made therein without departing from the scope of the present disclosure. Thus, embodiments should not be limited by any of the above-described exemplary embodiments, but should be defined only in accordance with the following claims and their equivalents.

What is claimed is:

1. A computer-implemented method comprising:
receiving an ad impression opportunity from a real-time bidded source of impression opportunities;
determining, based on information associated with the ad impression opportunity, a data spot to which the ad impression opportunity corresponds;
transmitting, to the real-time bidded source of impression opportunities, a bid for the ad impression opportunity, wherein the bid is determined according to a bidding strategy assigned to the data spot to which the ad impression opportunity corresponds;
receiving information regarding a sale of the ad impression opportunity; and
updating, based on the received information regarding the sale, the bidding strategy for the data spot to which the ad impression opportunity corresponds.

2. The computer-implemented method of claim 1, the received ad impression opportunity comprising information regarding a publisher or a user features that corresponds to the ad impression opportunity.

3. The computer-implemented method of claim 1, further comprising:
clustering a plurality of ad impression opportunities into a plurality of data spots, wherein the plurality of data spots includes the data spot to which the ad impression opportunity corresponds.

4. The computer-implemented method of claim 3, each of the plurality of ad impression opportunities comprising information regarding a publisher or a user features that corresponds to each ad impression opportunity, wherein clustering comprises clustering the plurality of ad impression opportunities according to the information corresponding to each ad impression opportunity.

5. The computer-implemented method of claim 3, further comprising:
determining one or more of an expectation of the cost per impression, a number of impressions used to derive the expectation of the cost per impression, a variance of data compared to the expected cost per impression, a number of bids submitted, and a number of bids won for each of the plurality of data spots.

6. The computer-implemented method of claim 1, wherein the bid is determined according to a bidding strategy comprising an explore bidding strategy, a true value bidding strategy, a less true value bidding with randomness strategy, or an opt out strategy.

7. The computer-implemented method of claim 6, further comprising:
assigning the bidding strategy to the data spot to which the ad impression opportunity corresponds based on a confidence level for the data spot and a value level associated with the data spot.

8. One or more computer-readable storage media comprising instructions that are executable to cause a device to perform a process comprising:
receiving information regarding a plurality of ad impression opportunities;
clustering, based on the received information, the plurality of ad impression opportunities into one or more data spots;
determining one or more boundaries for one or more categories into which the one or more data spots will be classified;
classifying, according to the boundaries, the one or more data spots into the one or more categories; and
assigning a bidding strategy to each of the one or more categories, wherein the bidding strategy assigned to the category is employed to determine a bid for a subsequent ad impression opportunity that corresponds to the one or more data spots in the category.

9. The one or more computer-readable storage media of claim 8, receiving information comprising receiving information regarding a publisher or a user features that corresponds to the ad impression opportunity, information that a transmitted bid is a winning bid, information that there has been a higher bid than a transmitted bid, information that that an auction for the ad impression opportunity was won or lost, or information regarding a winning bid amount.

10. The one or more computer-readable storage media of claim 8, assigning a bidding strategy to each of the one or more categories comprising:
assigning an explore bidding strategy to one or more categories that include one or more data spots having a confidence level categorized as low confidence;
assigning a less true value bidding with randomness strategy to one or more categories that include one or more data spots having a confidence level categorized as medium confidence;
assigning a true value bidding strategy to one or more categories that include one or more data spots having a confidence level categorized as high confidence and having a value level categorized as one of high value or medium value; and
assigning an opt out strategy to one or more categories that include one or more data spots having a confidence level categorized as high confidence level and having a value level categorized as low value.

11. The one or more computer-readable storage media of claim 8, the process further comprising:
subsequently altering the bidding strategy assigned to at least one of the one or more categories according to a defined business plan.

12. The one or more computer-readable storage media of claim 8, the process further comprising:
reclassifying at least one of the one or more data spots according to received information regarding the subsequent ad impression opportunity that corresponds to the at least one of the one or more data spots to be reclassified.

13. A device comprising:
one or more processors;
one or more computer-readable storage media; and
one or more modules embodied on the one or more computer-readable storage media and executable under the influence of the one or more processors, the one or more modules configured to:
receive, from an impression provider, an ad impression opportunity on which to bid;
determine, based on information regarding the ad impression opportunity, a data spot to which the ad impression opportunity corresponds, the data spot being comprised of a plurality of previously received ad impression opportunities;
transmit, to the impression provider, a bid for the ad impression opportunity, wherein the bid is determined according to a bidding strategy associated with a category into which the data spot is sorted.

14. The device of claim 13, the one or more modules being further configured to:
receive information regarding a sale of the ad impression opportunity; and
update the data spot to which the ad impression opportunity corresponds based on the received information.

15. The device of claim 13, wherein the one or more modules being configured to determine a data spot to which the ad impression opportunity corresponds comprises the one or more modules being configured to:
receive information regarding the plurality of previously received ad impression opportunities;
cluster, based on the received information, the plurality of previously received ad impression opportunities into one or more data spots;
determine one or more boundaries for one or more categories into which the one or more data spots will be classified into;
classify, according to the boundaries, the one or more data spots into the one or more categories; and
assign a bidding strategy to each of the one or more categories, wherein the bidding strategy assigned to the category into which the data spot that corresponds to the ad impression opportunity received from the impression provider is sorted is employed to determine the bid for the ad impression opportunity received from the impression provider that corresponds to the one or more data spots in the category.

16. The device of claim 15, wherein the one or more modules being configured to determine one or more boundaries comprises the one or more modules being configured to determine an upper boundary for a confidence level associated with each of the one or more data spots and a lower boundary for the confidence level associated with each of the one or more data spots.

17. The device of claim 16, wherein the one or more modules being configured to classify comprises the one or more modules being configured to classify the one or more data spots into one of a category including data spots associated with a confidence level above the upper boundary, a category including data spots associated with a confidence level below the lower boundary, or a category including data spots associated with a confidence level below the upper boundary and above the lower boundary.

18. The device of claim 15, wherein the one or more modules being configured to determine one or more boundaries comprises the one or more modules being configured to determine an upper boundary for a value of each of the one or more data spots and a lower boundary for the value of each of the one or more data spots.

19. The device of claim 18, wherein the one or more modules being configured to classify comprises the one or more modules being configured to classify the one or more data spots into one of a category including data spots with a value above the upper boundary, a category including data spots with a value below the lower boundary, or a category including data spots with a value below the upper boundary and above the lower boundary.

20. The device of claim 15, the one or more modules being further configured to:
recluster the plurality of previously received ad impression opportunities, including the ad impression opportunity received from the impression provider, into one or more data spots on a periodic basis.
